(19) United States
(12) Patent Application Publication
(10) Pub. No.: US 2016/0087317 A1
(43) Pub. Date: Mar. 24, 2016

(54) TRACTION BATTERY HEATER CONTROL

(71) Applicant: Lear Corporation, Southfield, MI (US)

(72) Inventors: Krzysztof KLESYK, Novi, MI (US); Sohaib IKRAM, Dearborn Heights, MI (US); Ehab TARMOOM, Allen Park, MI (US)

(21) Appl. No.: 14/489,865

(22) Filed: Sep. 18, 2014

(51) Int. Cl. H01M 10/637; H01M 10/615; H01M 10/625; H05B 1/02

(52) U.S. Cl. CPC H01M 10/637; H05B 1/0236; H01M 10/615; H01M 10/625; H01M 2220/20

(57) ABSTRACT

Vehicle high-voltage side heater systems and methods are described. In an example, a controller to input a modulated control signal from a low-voltage side is connected to a high-voltage side heater, which is controlled by the modulated control signal from the controller. The controller can be on low-voltage side and not directly connected to a low-voltage side power but does derive the control signal from an input signal, which can be pulse width modulated.

### TECHNICAL FIELD

This application relates to a structures and methods for controlling a traction battery heater and for heaters for high voltage side applications in hybrid electric vehicles.

### BACKGROUND

Some hybrid or electric vehicles require heat to keep the high voltage batteries in their operating range.

### SUMMARY

A vehicle high-voltage side heater system is described. An example of such a system can include a controller to input a modulated control signal from a low-voltage side and a high-voltage side heater. The heater can be electrically coupled to the controller and controlled by the modulated control signal from the controller to connect a high voltage to the high-voltage side heater. In an example, the controller is isolated from the high voltage side power.

In an example, the controller includes a power supply, control logic circuitry and a driver, all electrically coupled to provide the modulated control signal in response to a modulated input signal at the low-voltage side.

In an example, the modulated control signal is a pulse width modulated signal.

In an example, the low-voltage side is at 12 volts.

In an example, the high-voltage side is greater than 100 volts and includes a traction battery.

In an example, the high-voltage side heater is selectively connected to the high-voltage based on the modulated control signal.

In an example, the controller includes an electrostatic discharge circuit receiving an input signal from the vehicle circuitry requesting operation of the high-voltage side heater.

In an example, the controller includes an electro-magnetic inference limiting circuit that is electrically connected to the electrostatic discharge circuit.

In an example, the controller includes a low dropout regulator connected to the electro-magnetic inference limiting circuit and configured to output a transformer driver signal.

In an example, the controller includes a transformer circuit receiving the transformer driver signal and configured to output a high-voltage side switch control signal.

In an example, the controller includes power transistor that is controlled by the high-voltage side switch control signal to selectively connect the high-voltage side heater to the high-voltage side power.

Various methods are described and some exemplary methods can be used with the structures described herein. A method of controlling a high-voltage side heater in a vehicle can include receiving a modulated control signal on a low-voltage side and filtering the modulated control signal on the low-voltage side. The method can further include outputting a driver control signal based on the filtered modulated control signal on the low-voltage side. The method can further include driving a transformer based on the driver control signal on the low-voltage side and switching the high-voltage heater between on and off states based on a signal from the transformer.

In an example, none of the steps on the low-voltage side are directly connected to low-voltage power.

In an example, filtering includes limiting electrostatic voltages and electro-magnetic interference transients in the modulated control signal.

In an example, outputting the driver control signal includes outputting a sense signal and a reset signal based on the filtered modulated signal a threshold adjustment signal, a reset delay signal, and a sense input signal.

In an example, outputting the driver control signal includes applying to the sense signal and the reset signal to logic circuitry to produce the driver control signal that is “on” when the high-voltage heater is to be off and “off” when the high-voltage heater is to be on.

In an example, outputting the driver control signal includes using the reset delay signal for under-voltage lockout to protect a high-voltage side switch performing switching the high-voltage heater between on and off states by keeping the high-voltage side switch from its linear operating region.

In an example, outputting the driver control signal includes applying hysteresis on the state of the sense input signal to reduce effects of noise and ripple on the modulated control signal.

### BRIEF DESCRIPTION OF THE DRAWINGS

FIG. 1 is a schematic view of a control structure for high voltage side heating according to an embodiment.

FIG. 2 is a schematic view of a control structure for high voltage side heating according to an embodiment.

FIG. 3 is a schematic view of a control structure for high voltage side heating according to an embodiment.

FIG. 4 is a flow chart of a method for controlling high voltage side heating according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

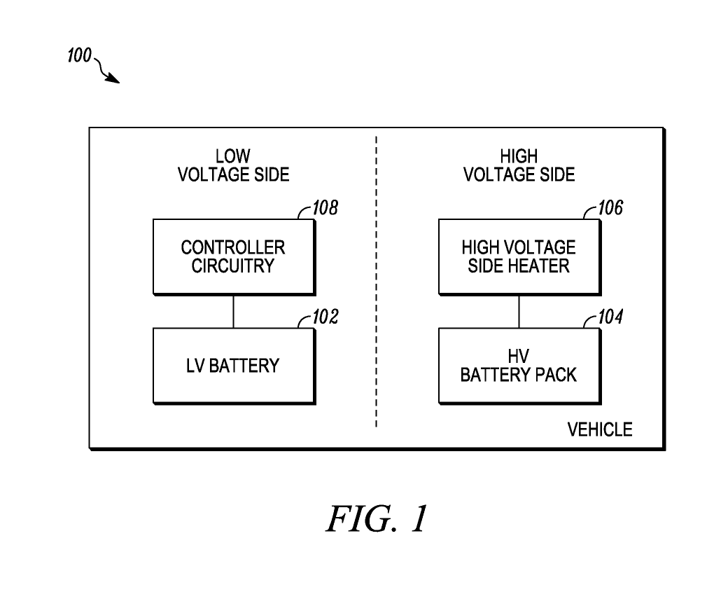

FIG. 1 shows a schematic view of a vehicle 100 that has a low voltage side and a high voltage (HV) side, which is typical in a hybrid electric vehicle or electric vehicle. The low voltage (LV) side is the typical vehicle electrical system found in vehicles. The low voltage side includes a battery 102 and an alternator to charge the battery. The low voltage side operates at a voltage which is conventionally less than 20 volts. A current standard for a low side voltage is 12 volts. The low voltage side can be electrically isolated from the high voltage side. The high voltage side also includes a battery or battery pack 104. However, the high voltage side is used to propel the vehicle 100, which requires a higher voltage, over 100 volts and in some applications operate at greater than 200 volts. At times it is required to heat the battery pack 104 or other components on the high voltage side. A heater 106 is supplied on the high voltage (HV) side to provide heat to the battery pack 104. In some applications, a battery 104 must be at a certain temperature to accept or produce electrical charge. Thus, in some cold climates the battery 104 must be heated. The HV side heater 106 is connected to the HV battery pack 104 and controlled by signals from a LV side controller circuitry 108. Controller circuitry 108 is positioned on the LV side and is powered by the LV battery 102 or other LV side power source. The controller circuitry 108 produces a pulse width modulated signal that is the sole signal to control and drive the switches that control operation of the HV heater. In an example, controller circuitry receives the pulse width modulated signal and outputs a control signal to control the HV side heater 106 without further connection to the LV side power source to control operation of the HV side heater 106. The HV heater 106 is thus positioned mechanically on the HV side but electrically controlled by the control signal from the LV side. The controller circuitry can include a solid-state relay to galvanically isolate its LV side components from the HV side power.

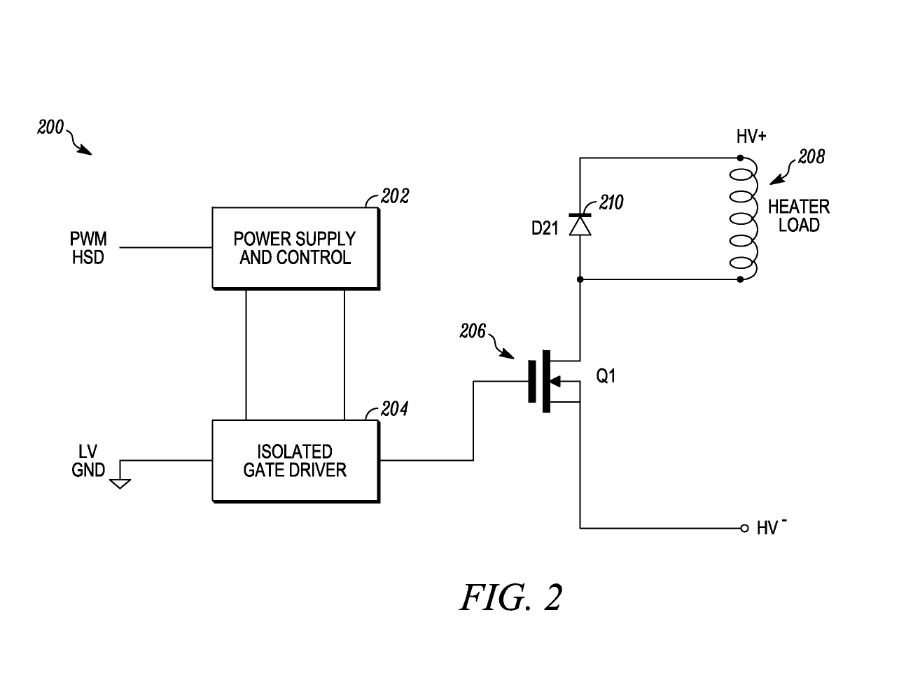

FIG. 2 shows a schematic view 200 of a control structure for high voltage side heating. Power supply and control circuitry 202 is connected to the low voltage side circuitry and receives a modulated signal for driving the HV side heater. The signal can be a pulse width modified (PWM) signal that is set for high side driving (HSD) of the high voltage side heater. This signal is produced by vehicle circuitry upon determination that the HV battery, e.g., the battery 104 of FIG. 1, must be heated. The circuitry 202 receives the modulated signal and outputs a signal to driver circuitry 204. The circuitry 202 can include a MOSFET to switch the signal applied to the driver circuitry 204. In an example, the circuitry 202 can further include a logical gate to switch the signal applied to the driver circuitry 204. Circuitry 202 can further include electrostatic discharge circuits, e.g., capacitors connected between the line in and ground as well as resistors to drain any such capacitors during an off state of the input signal. Circuitry 202 can include electromagnetic interference protection circuits along the input signal line to provide improved EMI immunity during implementation in vehicle by limiting peak currents in the input line. The circuitry 202 can further include a voltage regulator integrated circuit to smooth the signal to be applied to logic gates or the MOSFET. A comparator can also be part of the circuitry 202 to determine and output a reset signal and a comparator output signal. A reset threshold can be a set value of the system and can be programmed externally. A logic circuit, e.g., a NAND gate or its equivalent, can receive the reset signal and the comparator output signal and when both are low the logic circuit can output an enable signal to the driver circuitry 204. In an example, the driver circuitry 204 can include solid state components and operate to electrically isolate the LV side components from the HV side power.

The driver circuitry 204 can include a driver circuit to produce a signal to apply to a transformer. The driver circuit can output a 200 KHz signal to the transformer or two each of the two coils in a dual primary coil configuration. The transformer can step up the power from a primary input to a secondary output. The transformer can be a dual primary coil with a single secondary coil to be able to operate at close to a 50% duty cycle and can operate at a lower voltage than a single primary coil. Such a transformer can operate in a push-pull operation where the two primary coils operate opposite each other. The secondary output can further be conditioned before being applied to a switch 206 that applies high side voltage to a heater 208. The transformer can further operate to isolate the low-voltage side components from the high-voltage side power.

In the FIG. 2 example, the switch 206 is a power MOSFET that when it receives a conductive signal form the driver circuitry 204 ties the negative terminal of the heater 208 to the negative terminal of the high voltage side. The positive terminal of the heater 208 is connected to the positive terminal of the high voltage side. A freewheel diode 210 is positioned across the heater 208 to prevent back EMF from the HV high voltage terminal and protect the switch 206 from damage, e.g., from flyback, which is the sudden voltage spike seen across an inductive load when the supply is turned off. In this example, the signal that controls the switch 206 is derived from the modulated signal from the LV side and does not require additional power from the low voltage power supply or the high voltage power supply.

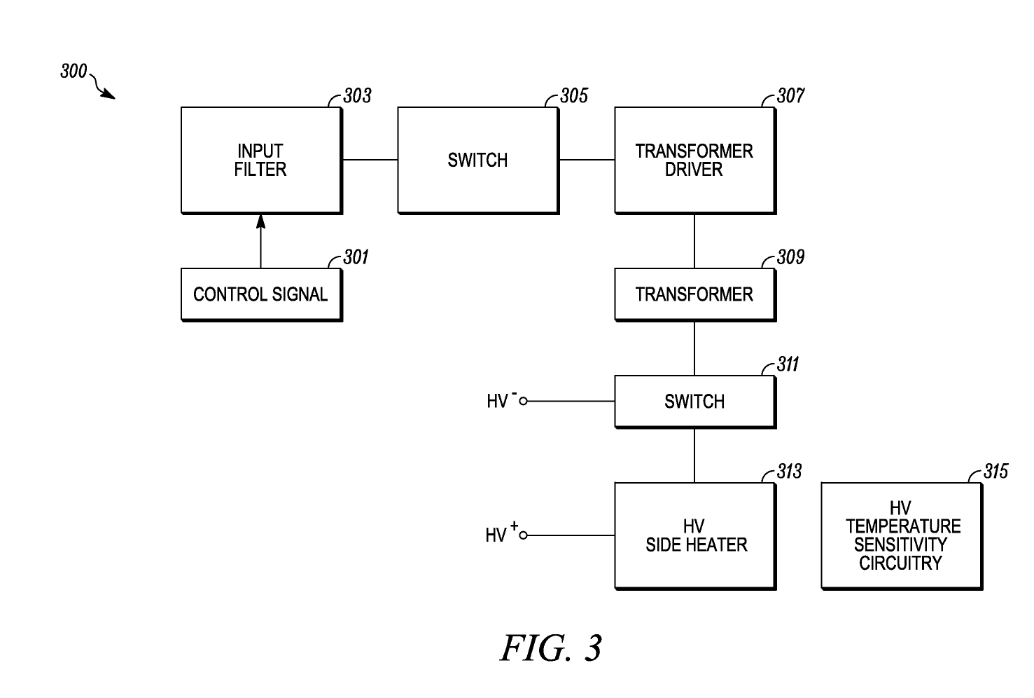

FIG. 3 shows another view of a control structure 300 for high voltage side heating. An HV side heater control signal 301 is supplied to an input filter 303 on the low voltage side. In an example, the control signal 301 can be a 10-400 HZ pulse width modulated signal. The input filter 303 operates to reduce the effects of electrostatic discharge and electromagnetic interference. A switch 305 is connected to the input filter 303 and based on the signal from the input filter outputs a control signal. In an example, the switch is a MOSFET. In another example, the switch 305 can be a low dropout regulator that receives the input signal from the input filter as well as reset delay signal, a sense input, and a reset threshold adjust signal. Using these inputs, the regulator can output a reset output signal and a sense output signal, which can be supplied to logic circuits. The logic circuit outputs a switched digital signal to a driver circuit 307. The driver circuit 307 receives the digital signal and drives an output signal to a primary side of the transformer 309. The transformer 309 operates to produce a switch control signal to apply to the HV side switch 311. The HV switch can be a power MOSFET that is capable of handling the HV side voltage, e.g., greater than 100 volts, greater than 200 volts, or greater than 400 volts, etc. In an example, the switch 311 connects the HV negative terminal to the HV side heater 313. The HV side heater 313 is also connected to the HV positive terminal. In operation, the duty cycle of the control signal 301 powers the HV side switch, through connects described herein, and sets the duty cycle for the heater 313.

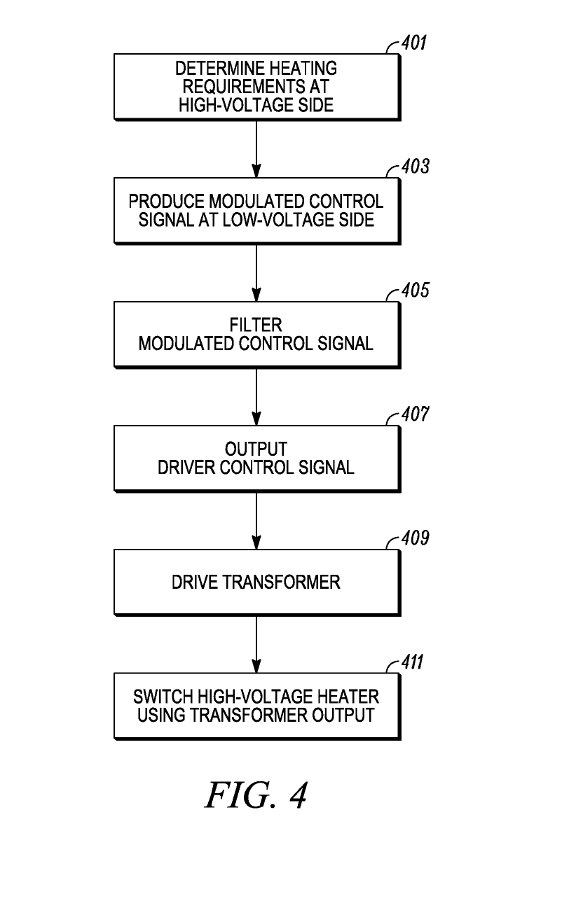

FIG. 4 shows a method for controlling a high-voltage side heater according to examples. At 401, the vehicle, through its various sensors, processors and control algorithms, determines that it is necessary to heat components on the high-voltage side. For example, certain types of traction batteries work best at or only within certain temperature ranges. It can thus be necessary in a hybrid or electric vehicle to heat the battery to at least its minimum operating temperature. At 403, the vehicle produces a modulated control signal at its low-voltage side. This signal can be pulse-width modulated and based on this signal the duty cycle of the HV heater is controlled. The modulated control signal can be in the range of 5 volts to 17 volts and with a frequency range of 10 Hz-400 Hz with a duty cycle of 0%-90%.

At 405, the modulated control signal can be filtered and processed to reduce the effect of stay signals, e.g., electro-magnetic interference and/or electrostatic signal input. It will be appreciated that various capacitors and resistors can be positioned on the input line and selected to damping or eliminate high frequency signal components, e.g., greater than 1 KHz, and high voltages, e.g., greater than 100 volts or 10 of volts greater than the input modulated control signal. The various electrical elements can be chosen based on the value of the input signal and other component values as is known in the art.

At 407, a driver control signal is output based on the filtered modulated control signal. In an example, an integrated circuit can receive the filtered modulated control signal as an input signal. The integrated circuit can receive a sense input signal that is the filtered modulated control signal that is passed through a voltage divider. The integrated circuit can further receive a delay signal to control how fast the integrated circuit switches the output. The integrated circuit can further receive a reset signal that is set by a voltage divider network. The reset function can be activated during a power up sequence or during normal operation if the output voltage drops outside the set limits. The reset threshold voltage can be decreased by the connection of an external resistor divider to a reset lead on the integrated circuit. The integrated circuit can be protected against reverse battery, short circuit, and thermal overload conditions, and can withstand load dump transients making it suitable for use in automotive environments. The selection of the reset threshold voltage the reset signal can provide hysteresis when producing the output based on the modulated control signal. In an example, the integrated circuit produces two output signals that can be passed to logic circuits to produce the driver control signal. In an example the integrated circuit produces a reset output signal and a sense output signal, which are supplied to a NAND gate with its output to the transformer driver.

At 409, the transformer is driven based on signals from step 407. Accordingly, as the input and output from step 407 are pulse modulated signals at the low-voltage side, the input to a transformer driver is also pulse width controlled and modified by the reset signal. In an example, an integrated circuit driver is provided and it sends driving signals to a two coil primary side of the transformer. These driver output signals work in opposition so that the two coil primary side operates in a push-pull configuration with the single coil secondary. The integrated circuit can output a signal when its input from step 407 is off and not output signal when its input from step 407 is positive.

At 411, the transformer output is applied to a switch at the high-voltage side. This switch selectively connects the HV heater to the HV power. In an example, the HV switch is a power MOSFET with the transformer output connected to a gate of the power MOSFET. In an example, the HV heater has one terminal connected to the positive HV power supply and another terminal connected to a drain of the power MOSFET. The source of the power MOSFET is connected to the HV negative terminal. Accordingly when the switch is conducting, i.e., gate is powered; the HV power is applied to the HV heater. When in the switch is off, then a flywheel diode connected from the drain to the HV positive terminal in parallel with the heater protects the heater.

The above described embodiments address the need to control a HV-side heater with a control signal from the low voltage (LV) side. It is within the scope of the present disclosure to use the teachings of the present disclosure to control HV loads other than heaters. This can be desirable when it is easier to build LV side circuitry to control loads on the HV side. However, the LV circuitry can be galvanically isolated from the HV side power.

It will be recognized that in some embodiments, the elements on the low side are not connected directly to the low voltage on the low side. The input signal is used to derive the signal to the transformer to switch the HV side switch that connects the high voltage on the HV side to the heater. It will be recognized that when integrated circuits are used, then they may be connected to an IC rail, e.g., 5 volts or 3.3 volts, and not directly connected to the LV side power. However, the IC rail can be derived from the LV side power.

The present inventors have found that the presently described design provides various benefits. Some of which include, but are not limited to, the reduction in the number of inputs required to drive and control the HV heater. The circuitry to drive and control the HV heater can be assembled in to a single module that has an input signal from the LV side and connects the heater on the HV side. In an example, single module need not include the heater. The heater can be a component of the battery pack with connections to the output of such a single module. Moreover, there is no need to connect the single module to the LV power terminal directly, e.g., there is no direct connection to the positive LV side power rail. Such a compact design can accommodate 2 kWatt heater power as it is on the HV side and uses a HV power switch to connect the heater to the HV supply.

It is further recognized that various examples do not require a heat sink as the components do not operate directly on the LV supply of the vehicle and only the power switch and the heater are subject to the HV supply.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle high-voltage side heater system, comprising:
a controller to input a modulated control signal from a low-voltage side; and
a high-voltage side heater electrically coupled to and galvanically isolated from the controller, the high-voltage side heater being controlled by the modulated control signal from the controller to connect a high voltage to the high-voltage side heater.

2. The system of claim 1, wherein the controller includes a power supply, control logic circuitry and a driver, all electrically coupled to provide the modulated control signal in response to a modulated input signal at the low-voltage side.

3. The system of claim 2, wherein the modulated control signal is a pulse width modulated signal.

4. The system of claim 3, wherein the low-voltage side is at 12 volts.

5. The system of claim 4, wherein the high-voltage side is greater than 100 volts and includes a traction battery.

6. The system of claim 5, wherein the high-voltage side heater is selectively connected to the high-voltage based on the modulated control signal.

7. The system of claim 1, wherein the controller includes an electrostatic discharge circuit receiving an input signal from vehicle circuitry requesting operation of the high-voltage side heater.

8. The system of claim 7, wherein the controller includes an electro-magnetic inference limiting circuit that is electrically connected to the electrostatic discharge circuit.

9. The system of claim 8, wherein the controller includes a low dropout regulator connected to the electro-magnetic inference limiting circuit and configured to output a transformer driver signal.

10. The system of claim 9, wherein the controller includes a transformer circuit receiving the transformer driver signal and configured to output a high-voltage side switch control signal.

11. The system of claim 10, wherein the controller includes power transistor that is controlled by the high-voltage side switch control signal to selectively connect the high-voltage side heater to high-voltage side power.

12. A method of controlling a high-voltage side heater in a vehicle, comprising:
receiving a modulated control signal on a low-voltage side;
filtering the modulated control signal on the low-voltage side;
outputting a driver control signal based on the filtered modulated control signal on the low-voltage side;
driving a transformer based on the driver control signal on the low-voltage side; and
switching the high-voltage heater between on and off states based on a signal from the transformer.

13. The method of claim 12, wherein none of the steps on the low-voltage side are directly connected to low-voltage power.

14. The method of claim 12, wherein filtering includes limiting electrostatic voltages and electro-magnetic interference transients in the modulated control signal.

15. The method of claim 12, wherein outputting the driver control signal includes outputting a sense signal and a reset signal based on the filtered modulated signal a threshold adjustment signal, a reset delay signal, and a sense input signal.

16. The method of claim 15, wherein outputting the driver control signal includes applying to the sense signal and the reset signal to logic circuitry to produce the driver control signal that is “on” when the high-voltage heater is to be off and “off” when the high-voltage heater is to be on.

17. The method of claim 16, wherein outputting the driver control signal includes using the reset delay signal for under-voltage lockout to protect a high-voltage side switch performing switching the high-voltage heater between on and off states by keeping the high-voltage side switch from its linear operating region.

18. The method of claim 17, wherein outputting the driver control signal includes applying hysteresis on the state of the sense input signal to reduce effects of noise and ripple on the modulated control signal.

19. A vehicle with a high-voltage side and a low-voltage side, comprising:
a controller to input a modulated control signal from the low-voltage side;
a solid state relay switch electrically connected to and driven by the modulated control signal; and
a high-voltage side load electrically coupled to and galvanically isolated from the controller through the solid state relay switch, the high-voltage side load being controlled by the modulated control signal through the solid state relay to connect a high voltage to the high-voltage side load.

20. The vehicle of claim 19, wherein the controller includes a power supply, control logic circuitry and a driver, all electrically coupled to provide the modulated control signal in response to a modulated input signal at the low-voltage side
wherein the modulated control signal is a pulse width modulated signal;
wherein the low-voltage side is less than 20 volts;
wherein the high-voltage side is greater than 100 volts and includes a traction battery; and
wherein the high-voltage side load is selectively electrically connected to the high-voltage based on the modulated control signal controlling the solid state relay.
